(19) United States
(12) Patent Application Publication
(10) Pub. No.: US 2012/0265515 A1
(43) Pub. Date: Oct. 18, 2012

(54) METHOD AND SYSTEM AND COMPUTER PROGRAM PRODUCT FOR ACCELERATING SIMULATIONS

(76) Inventor: Reuven WEINTRAUB, Ein Ayyala (IL)

(21) Appl. No.: 13/084,583

(22) Filed: Apr. 12, 2011

(51) Int. Cl. G06F 17/50

(52) U.S. Cl. 703/15

(57) ABSTRACT

Method, system, and computer program product. The method may include: receiving a model of a circuit that includes logic that is designed to receive sequence information and/or constants from input modules of the circuit. Updating the model or generating a new model that includes an interface and an initialization module. The initialization module may provide, to a hardware accelerator and during an initialization of a simulation of the circuit, the constants and/or the sequence information. The interface may interface between a simulator and a hardware accelerator that includes one or more FPGAs. Generating FPGA code of an amended logic that includes the logic and a programmable module; wherein the programmable module may receive, during the initialization of the simulation, the constants and/or the sequence information, and to provide during the simulation and to the logic, at least one out of the constants and a sequence represented by the sequence information.

### BACKGROUND OF THE INVENTION

Integrated circuits are highly complex and require to adhere with strict timing constraints. The design process of integrated circuits includes simulating circuits in order to evaluate their functionality

There is a growing need to speed up the simulation process and also make the simulation process more tolerable to changes in the information provided to the logic.

### SUMMARY

A method for configuring a simulator and a hardware accelerator. According to an embodiment of the invention the method may include: receiving a model of a circuit that comprises logic that is designed to receive at least one out of sequence information and constants from at least one input module of the circuit; updating the model of the circuit or generating a new model of the circuit, the model comprises an interface and an initialization module, wherein the initialization module is arranged to provide, to a hardware accelerator and during an initialization of a simulation of the circuit, at least one out of constants and the sequence information; wherein the interface is arranged to interface between a simulator that simulates the at least one input module and a hardware accelerator that comprises a Field Programmable Gate Array (FPGA); and generating FPGA code of an amended logic that comprises the logic and a programmable module; wherein the programmable module is arranged to receive, during the initialization of the simulation, at least one out of the constants and the sequence information, and to provide during the simulation and to the logic, at least one out of (a) the constants, and (b) at least one sequence represented by the sequence information.

The sequence information may be the sequence and the programmable module may be a buffer arranged to store the sequence and to output the sequence during the simulation.

The sequence information may include parameters that represent the sequence and wherein the programmable module comprises a pattern generator that is arranged to output the sequence based on the parameters.

The sequence information may represent a cyclic sequence and wherein the programmable module is arranged to output the sequence in a cyclic manner during the simulation.

The method may include updating the model of the circuit to comprise the initialization module, wherein the initialization module is arranged to provide, to the hardware accelerator, the sequence information during an initialization of a simulation iteration of the circuit.

The sequence information may represent a sequence that has a first portion and a second portion wherein the second portion comprises multiple repetitions of a same value.

The method may include updating the model of the circuit to comprise the initialization module, wherein the initialization module is arranged to provide, to the hardware accelerator, the constants during an initialization of a simulation iteration of the circuit.

The method may include updating the model of the circuit to comprise the interface and the initialization module, wherein the initialization module is arranged to provide, to a hardware accelerator and during an initialization of a simulation of the circuit, constants; and generating the FPGA code of the amended logic that comprises the logic and a programmable module; wherein the programmable module is arranged to receive, during the initialization of the simulation, the constants, and to provide during the simulation and to the logic, the constants.

The method may include updating the model of the circuit to comprise the interface and the initialization module, wherein the initialization module is arranged to provide, to a hardware accelerator and during an initialization of a simulation of the circuit, sequence information; and generating the FPGA code of the amended logic that comprises the logic and a programmable module; wherein the programmable module is arranged to receive, during the initialization of the simulation, the sequence information, and to provide during the simulation and to the logic, the sequence.

The method may include changing of value of either one of the constants and the sequence comprises information without re-generating the FPGA code.

The method may include simulating the circuit by the simulator and the hardware accelerator using the amended logic, wherein the simulating comprises sending input signals from the simulator to the hardware accelerator and sending output signals from the hardware accelerator to the simulator.

The method may include storing at least a portion of the sequence information in a memory module of the hardware accelerator, the memory module is coupled to the FPGA.

The FPGA code may include multiple FPGA code segments and the method may include programming multiple FPGAs of the hardware accelerator by the multiple FPGA code segments.

The hardware accelerator may include multiple boards.

According to an embodiment of the invention a computer program product may be provided and may include a non-transitory computer readable medium that stores instructions for: receiving a model of a circuit that comprises logic that is designed to receive at least one out of sequence information and constants from at least one input module of the circuit; updating the model of the circuit or generating a new model of the circuit, the model comprises an interface and an initialization module, wherein the initialization module may be arranged to provide, to a hardware accelerator and during an initialization of a simulation of the circuit, at least one out of constants and the sequence information; wherein the interface may be arranged to interface between a simulator that simulates the at least one input module and a hardware accelerator that comprises a Field Programmable Gate Array (FPGA); and generating FPGA code of an amended logic that comprises the logic and a programmable module; wherein the programmable module may be arranged to receive, during the initialization of the simulation, at least one out of the constants and the sequence information, and to provide during the simulation and to the logic, at least one out of (a) the constants, and (b) at least one sequence represented by the sequence information.

The sequence information may be the sequence and the programmable module may be a buffer arranged to store the sequence and to output the sequence during the simulation.

The sequence information may include parameters that represent the sequence and wherein the programmable module comprises a pattern generator that may be arranged to output the sequence based on the parameters.

The sequence information may represent a cyclic sequence and wherein the programmable module may be arranged to output the sequence in a cyclic manner during the simulation.

The non-transitory computer readable medium may store instructions for updating the model of the circuit to comprise the initialization module, wherein the initialization module may be arranged to provide, to the hardware accelerator, the sequence information during an initialization of a simulation iteration of the circuit.

The sequence information may represent a sequence that has a first portion and a second portion wherein the second portion comprises multiple repetitions of a same value.

The non-transitory computer readable medium may store instructions for updating the model of the circuit to comprise the initialization module, wherein the initialization module may be arranged to provide, to the hardware accelerator, the constants during an initialization of a simulation iteration of the circuit.

The non-transitory computer readable medium may store instructions for: updating the model of the circuit to comprise the interface and the initialization module, wherein the initialization module may be arranged to provide, to a hardware accelerator and during an initialization of a simulation of the circuit, constants; and generating the FPGA code of the amended logic that comprises the logic and a programmable module; wherein the programmable module may be arranged to receive, during the initialization of the simulation, the constants, and to provide during the simulation and to the logic, the constants.

The non-transitory computer readable medium may store instructions for: updating the model of the circuit to comprise the interface and the initialization module, wherein the initialization module may be arranged to provide, to a hardware accelerator and during an initialization of a simulation of the circuit, sequence information; and generating the FPGA code of the amended logic that comprises the logic and a programmable module; wherein the programmable module may be arranged to receive, during the initialization of the simulation, the sequence information, and to provide during the simulation and to the logic, the sequence.

The non-transitory computer readable medium may store instructions for changing of value of either one of the constants and the sequence comprises information without re-generating the FPGA code.

The non-transitory computer readable medium may store instructions for simulating the circuit by the simulator and the hardware accelerator using the amended logic, wherein the simulating comprises sending input signals from the simulator to the hardware accelerator and sending output signals from the hardware accelerator to the simulator.

The non-transitory computer readable medium may store instructions for storing at least a portion of the sequence information in a memory module of the hardware accelerator, the memory module is coupled to the FPGA.

The FPGA code may include multiple FPGA code segments and the non-transitory computer readable medium may store instructions for programming multiple FPGAs of the hardware accelerator by the multiple FPGA code segments.

The hardware accelerator may include multiple boards.

According to an embodiment of the invention a system is provided and may include a simulator, a code generator and a hardware accelerator. The simulator may be arranged to generate inputs to input modules and to receive outputs from output modules. The hardware accelerator may include a Field Programmable Gate Array (FPGA). The code generator may be arranged to: receive a model of a circuit that comprises logic that is designed to receive at least one out of sequence information and constants from the input modules; update the model of the circuit or generate a new model of the circuit, the model comprises an interface and an initialization module, wherein the initialization module may be arranged to provide, to a hardware accelerator and during an initialization of a simulation of the circuit, at least one out of constants and the sequence information; wherein the interface may be arranged to interface between a simulator that simulates the at least one input module and a hardware accelerator that comprises a Field Programmable Gate Array (FPGA); and generate FPGA code of an amended logic that comprises the logic and a programmable module; wherein the programmable module may be arranged to receive, during the initialization of the simulation, at least one out of the constants and the sequence information, and to provide during the simulation and to the logic, at least one out of (a) the constants, and (b) at least one sequence represented by the sequence information; wherein the interface may be arranged to interface between the simulator and the hardware accelerator that comprises a Field Programmable Gate Array (FPGA).

The code generator may be arranged to generate FPGA code of an amended logic that comprises the logic and a programmable module; wherein the programmable module may be arranged to receive, during the initialization of the simulation, at least one out of the constants and the sequence information, and to provide during the simulation and to the logic, at least one out of the constants and a sequence represented by the sequence information.

The simulator and the hardware accelerator may be arranged to exchange signals during a simulation of the circuit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a graphical representation of a circuit;

FIG. 2 illustrates a system according to an embodiment of the invention;

FIG. 3 provides a graphic illustration of an amended model of a circuit according to an embodiment of the invention;

FIGS. 4 and 5 illustrate a method according to an embodiment of the invention; and

FIG. 6 illustrates a system according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The simulation of a circuit is accelerated using a hardware accelerator that includes one or more Field Programmable Gate Arrays (FPGAs). The hardware accelerator simulates the logic of a circuit in order to speed up the simulation. The communication between the hardware accelerator and a simulator (that generates inputs to the circuit) is reduced by providing constants and sequence information to the FPGA during an initialization stage—instead of constantly providing constants and sequence values to the FPGA. The latter may include providing constants and sequence portions during each clock cycle. The sequence information can represent one or more sequences.

Instead of programming constants in the FPGA code (and thus re-compiling the FPGA code whenever a constant changes), the constants are provided to a programmable module of the FPGA, wherein a change in a value of a constant requires to provide the changed constant to the programmable module during initialization—without re-compiling the FPGA code.

Instead of programming a sequence in the FPGA code (and thus re-compiling the FPGA code whenever the sequence changes), sequence information is provided to a programmable module of the FPGA, wherein a change in a value of the sequence requires to provide changed sequence information to the programmable module during initialization—without re-compiling the FPGA code.

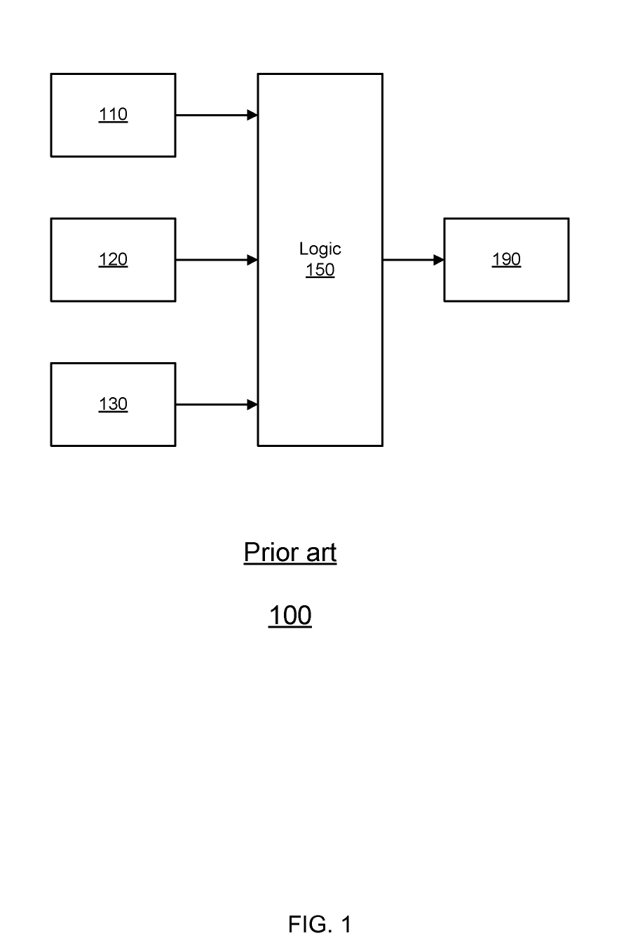

FIG. 1 illustrates a graphical representation of a circuit 100. The circuit 100 can be designed using a graphic design tool such as but not limited to Mathwork's Simulink. The circuit 100 is illustrated as including multiple input modules 110, 120 and 130, logic 150 and output module 190.

It is noted that the number of input modules may exceed three, the number of output modules may exceed one and the hardware accelerator can include multiple FPGAs and can include multiple Printed Circuit Boards.

Each input module (out of 110, 120 and 130) can represent electrical circuit, logical gates, and the like and is arranged to provide inputs to logic 150. The inputs can include constants (which may remain constant during the entire simulation of the circuit or at least during each simulation iteration), sequences and input streams. For example, input module 110 can provide an input stream, input module 120 can provide constants and input module 130 can provide sequences. The sequences are shorter than the input stream and it may be beneficial to provide them during an initialization of the simulation (or simulation iteration).

The sequences can include cyclic sequences or non-cyclic sequences. A cyclic sequence can include repetitions of sequences and can include combinations of sequences and constants. The sequences can be defined in a recursive manner or a non-recursive manner.

The sequence can include a first portion and a second portion. The second portion can include repetitions of the same value—that may be taken from the first portion or determined in another manner. Thus, a first portion can be followed by a sequence of zeroes, or ones, or the last value of the sequence, or the first value of the sequence or any other constant value.

During simulation, the logic is emulated by the hardware accelerator and other parts of the circuit are simulated by a simulator. In some cases the simulator can host the graphic design tool. It can be a computer of any type that is equipped with simulation software.

During each clock cycle the input modules 110, 120 and 130 output input stream elements, constants and sequence elements. For example, if the input stream represents pixels of an image that should be filtered by an N×N element spatial filter then during each clock cycle the entire N×N elements as well as a pixel are sent to the logic 150.

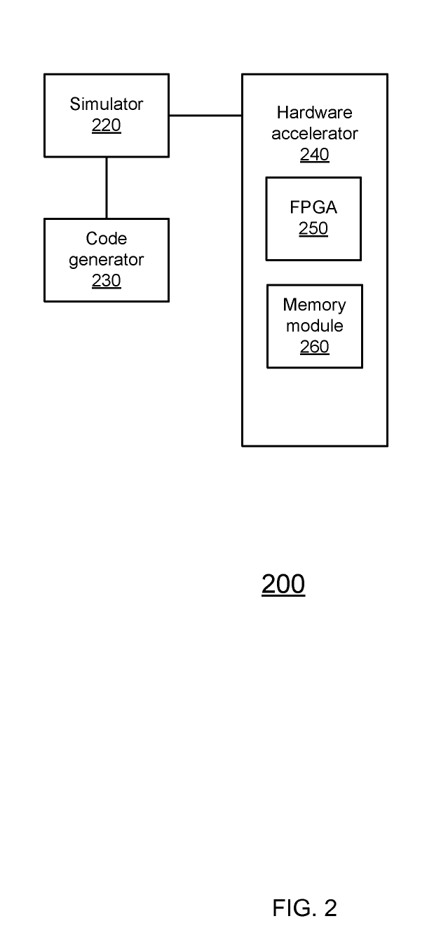

FIG. 2 illustrates a system 200 according to an embodiment of the invention.

System 200 includes a simulator 220, a code generator 230 and a hardware accelerator 240.

The simulator 220 is arranged to simulate (during which it may generate input signals of) the input modules of a circuit (such as input modules 110, 120 and 130 and to receive the outputs from the output module of a circuit (such as output module 190).

The hardware accelerator 240 includes Field Programmable Gate Array (FPGA) 250 and may include additional hardware components such as a memory module 260. It is arranged to simulate the logic 150. The hardware accelerator can include multiple FPGAs, can include a printed circuit board that contains one or more FPGAs and associated logic, can include multiple printed circuit boards that each contains one or more FPGAs and associated logic, and the like.

The code generator 230 is arranged to:
i. Receive a model of the circuit, the circuit includes logic (such as logic 150), the logic is designed to receive at least one out of sequence information and constants from the input module. The model can be generated by using tools such as Simulink of MathWorks or MATLAB of MathWorks.
ii. Update the model of the circuit (or otherwise generate a new model), the model shall include an interface and an initialization module. The initialization module is arranged to provide, to the hardware accelerator 240 during an initialization of a simulation of the circuit, at least one out of constants and the sequence information. The interface is arranged to interface between the simulator 220 and the hardware accelerator 240;
iii. Generate FPGA code of an amended logic that comprises the logic and a programmable module. This includes compiling a Hardware Description Language (HDL) representation of the amended logic and generating a Raw Binary File (RBF) representation of the FPGA.

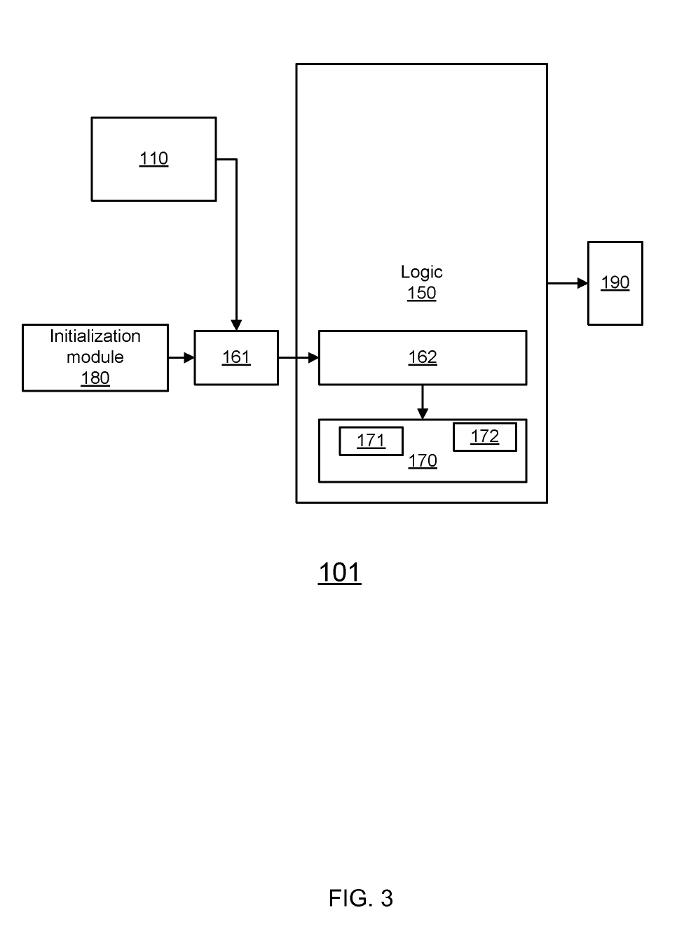

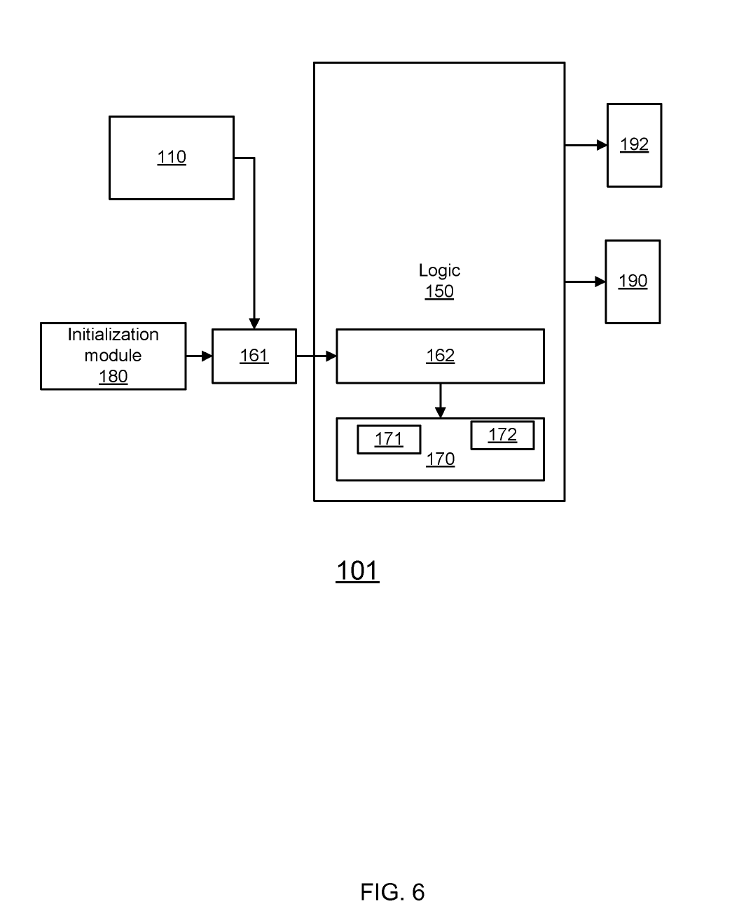

FIG. 3 provides a graphic illustration of an amended model of circuit 101 that further includes an initialization module 180. FIG. 6 provides a graphic illustration of an amended model of circuit 102 that further includes an initialization module 180 and also includes two output modules 190 and 192—instead of a single output module illustrated in FIG. 3.

Interface units 161 and 162 (collectively referred to as interface 160) and a programmable module 170 according to an embodiment of the invention. Interface unit 161 is included in the simulator while interface unit 162 is included in the hardware accelerator. The programmable module 170 is implemented by the FPGA 250—and is represented by the FPGA code. The programmable module 170 is arranged to receive, during the initialization of the simulation, at least one out of the constants and the sequence information, and to provide during the simulation and to the logic 150, at least one out of the constants and a sequence represented by the sequence information.

The simulator 220 and the hardware accelerator 240 may exchange signals during a simulation of the circuit. The simulator 220 can simulate (and thus generate inputs to) an input module (such as 110) and provide the hardware accelerator an input stream during the simulation.

The sequence information can be the sequence itself and the programmable module 170 can include a register, a set of registers or a buffer 171 (or another storage unit) and a retrieval circuit 172 that retrieves the sequence during the simulation. The retrieval circuit can include a counter or a combination of counters. The counter can scan the buffer in response to a progress in the simulation process. It is noted that the retrieval circuit can include a programmable counter that may be programmed to count multiple clock cycles before increasing its output.

Yet according to another embodiment of the invention the sequence information can include a set of sequence elements and a set of sequence element repetition metadata or timing metadata that indicate how much time each sequence element should appear in the sequence and, additionally or alternatively, during which period each sequence element should be outputted.

According to an embodiment of the invention, the sequence information may include parameters that represent the sequence and the programmable module 170 may include a pattern generator that is arranged to output the sequence based on the parameters. Any known pattern generator can be used as long as it can generate sequences based on parameters.

The sequence can include, for example, a cyclic sequence and wherein the programmable module 170 can output the sequence in a cyclic manner during the simulation. A buffer can store the sequence and a counter can repetitively scan the buffer and output the sequence elements in a cyclic manner.

According to an embodiment of the invention the constants and additionally or alternatively the sequence information can be updated between one simulation to another or between one simulation iteration to another. The update includes providing updated constants (one or more) or updated sequence information to the initialization module 180 (for example- by updating the Simulink model) and allowing the system to initialize—as during the initialization the updated constants or updated sequence information is sent from the initialization module 180 to the programmable module 170.

This update does not require re-generating the FPGA code—does not require to compile the FPGA code.

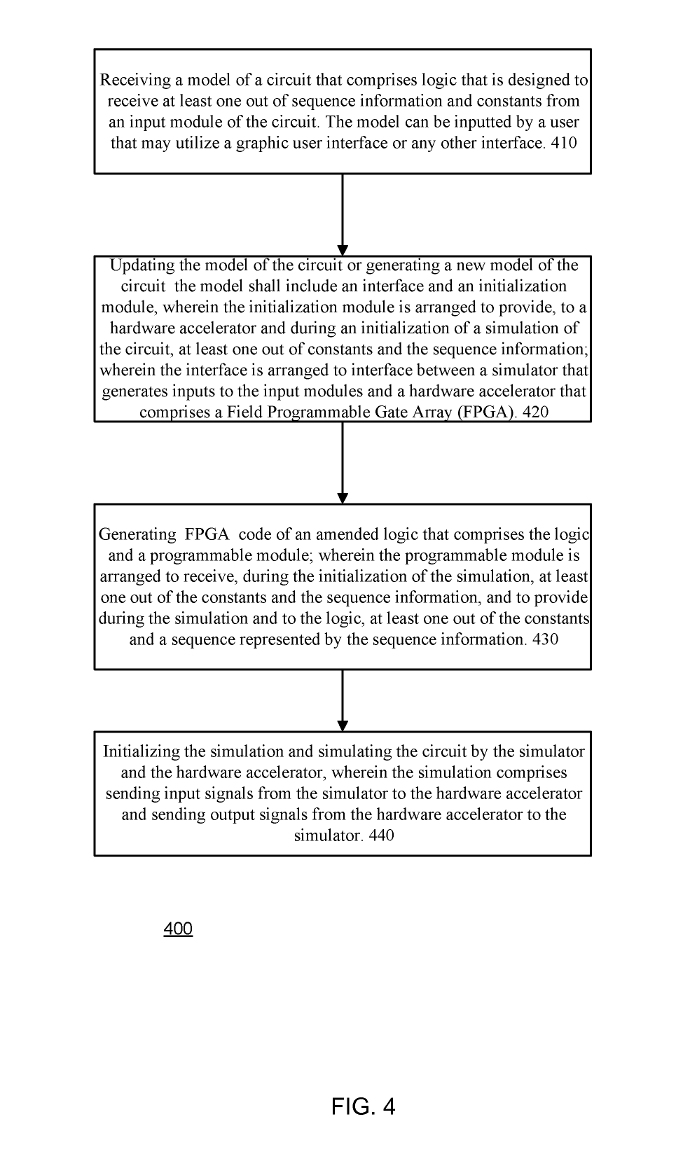

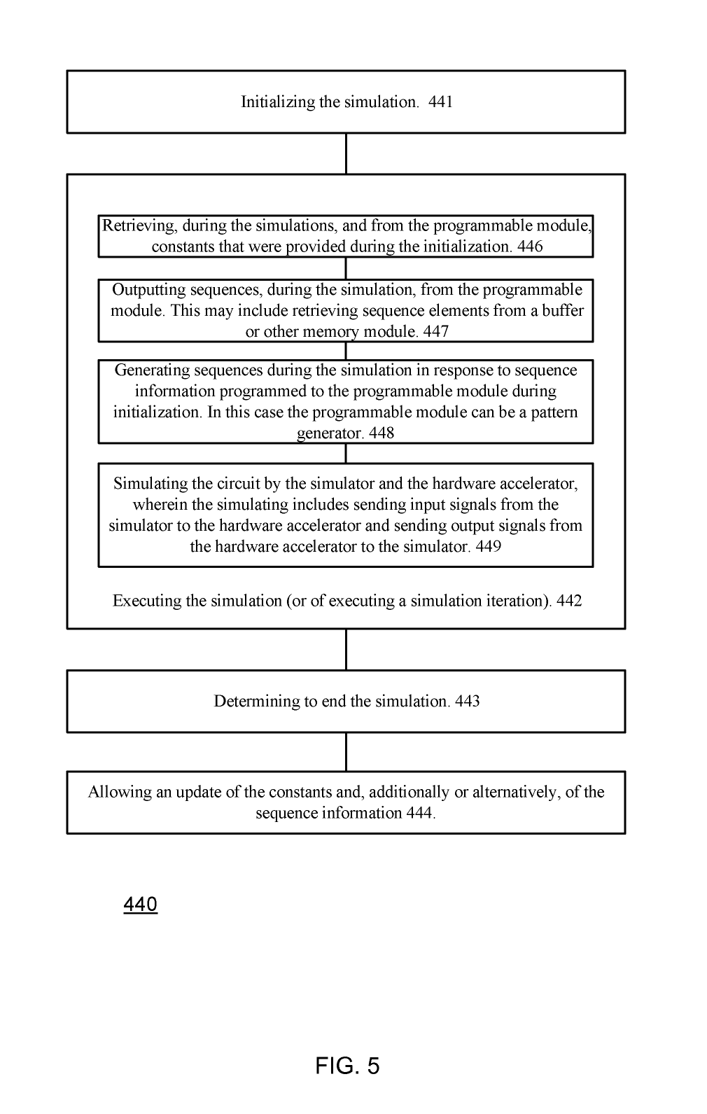

FIGS. 4 and 5 illustrate a method 400 according to an embodiment of the invention.

Method 400 starts by stage 410 of receiving a model of a circuit that comprises logic that is designed to receive at least one out of sequence information and constants from an input module of the circuit. The model can be inputted by a user that may utilize a graphic user interface or any other interface.

Stage 410 is followed by stage 420 of updating the model of the circuit or generating a new model of the circuit, the model shall include an interface and an initialization module, wherein the initialization module is arranged to provide, to a hardware accelerator and during an initialization of a simulation of the circuit, at least one out of constants and the sequence information; wherein the interface is arranged to interface between a simulator that generates inputs to the input modules and a hardware accelerator that comprises a Field Programmable Gate Array (FPGA).

Stage 420 is followed by stage 430 of generating FPGA code of an amended logic that comprises the logic and a programmable module; wherein the programmable module is arranged to receive, during the initialization of the simulation, at least one out of the constants and the sequence information, and to provide during the simulation and to the logic, at least one out of the constants and a sequence represented by the sequence information.

Stage 430 is followed by stage 440 of initializing the simulation and simulating the circuit by the simulator and the hardware accelerator, wherein the simulation comprises sending input signals from the simulator to the hardware accelerator and sending output signals from the hardware accelerator to the simulator. Stage 440 may include at least one of the following:
i. Stage 441 of initializing the simulation. Stage 441 may include sending, by the simulator constants or sequence information (or both) to the programmable module of the hardware accelerator. The programmable module can be (or can include) a memory module that can be a part of the FPGA or be connected to the FPGA.
ii. Stage 442 of executing the simulation (or of executing a simulation iteration).
iii. Stage 443 of determining to end the simulation.
iv. Stage 444 of allowing an update of the constants and, additionally or alternatively, of the sequence information and jumping to stage 441.
v. Stage 444 may include changing of a value of either one of the constants and the sequence comprises information without re-generating the FPGA code.

Stage 442 may include at least one of the following:
i. Stage 446 of retrieving, during the simulation, and from the programmable module, constants that were provided during the initialization.
ii. Stage 447 of outputting sequences, during the simulation, from the programmable module. This may include retrieving sequence elements from a buffer or another memory module.
iii. Stage 448 of generating sequences during the simulation in response to sequence information programmed to the programmable module during initialization. In this case the programmable module can be a pattern generator. The sequence may be a cyclic sequence and stage 448 can include outputting the sequence in a cyclic manner.
iv. Stage 449 of simulating the circuit by the simulator and the hardware accelerator, wherein the simulation includes sending input signals from the simulator to the hardware accelerator and sending output signals from the hardware accelerator to the simulator.

Method 400 can include, for example, receiving a Simulink model of a circuit, generating HDL code of an amended circuit, compiling the FPGA code (generating an RBF file) and configuring the FPGA with the RBF file. The hardware accelerator can be, for example, a ProcHILs of GiDEL limited of Israel.

A computer program product may be provided. It may include (or be) a non-transitory computer readable medium. It stores instructions that can be read by a computer and cause the computer to execute any of the mentioned above methods. The computer readable medium can be a physical entity such as a storage module, a memory device, a disk, a diskette, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for configuring a simulator and a hardware accelerator, the method comprises:
receiving a model of a circuit that comprises logic that is designed to receive at least one out of sequence information and constants from at least one input module of the circuit;
updating the model of the circuit or generating a new model of the circuit, the model comprises an interface and an initialization module, wherein the initialization module is arranged to provide, to a hardware accelerator and during an initialization of a simulation of the circuit, at least one out of constants and the sequence information; wherein the interface is arranged to interface between a simulator that simulates the at least one input module and a hardware accelerator that comprises a Field Programmable Gate Array (FPGA); and
generating FPGA code of an amended logic that comprises the logic and a programmable module; wherein the programmable module is arranged to receive, during the initialization of the simulation, at least one out of the constants and the sequence information, and to provide during the simulation and to the logic, at least one out of (a) the constants, and (b) at least one sequence represented by the sequence information.

2. The method according to claim 1, wherein the sequence information is the sequence and wherein the programmable module is a buffer arranged to store the sequence and to output the sequence during the simulation.

3. The method according to claim 1, wherein the sequence information comprises parameters that represent the sequence and wherein the programmable module comprises a pattern generator that is arranged to output the sequence based on the parameters.

4. The method according to claim 1, wherein the sequence information represents a cyclic sequence and wherein the programmable module is arranged to output the sequence in a cyclic manner during the simulation.

5. The method according to claim 1, comprising updating the model of the circuit to comprise the initialization module, wherein the initialization module is arranged to provide, to the hardware accelerator, the sequence information during an initialization of a simulation iteration of the circuit.

6. The method according to claim 1, wherein the sequence information represents a sequence that has a first portion and a second portion wherein the second portion comprises multiple repetitions of a same value.

7. The method according to claim 1, comprising updating the model of the circuit to comprise the initialization module, wherein the initialization module is arranged to provide, to the hardware accelerator, the constants during an initialization of a simulation iteration of the circuit.

8. The method according to claim 1, comprising:
updating the model of the circuit to comprise the interface and the initialization module, wherein the initialization module is arranged to provide, to a hardware accelerator and during an initialization of a simulation of the circuit, constants; and
generating the FPGA code of the amended logic that comprises the logic and a programmable module; wherein the programmable module is arranged to receive, during the initialization of the simulation, the constants, and to provide during the simulation and to the logic, the constants.

9. The method according to claim 1, comprising:
updating the model of the circuit to comprise the interface and the initialization module, wherein the initialization module is arranged to provide, to a hardware accelerator and during an initialization of a simulation of the circuit, sequence information; and
generating the FPGA code of the amended logic that comprises the logic and a programmable module; wherein the programmable module is arranged to receive, during the initialization of the simulation, the sequence information, and to provide during the simulation and to the logic, the sequence.

10. The method according to claim 1, comprising changing of value of either one of the constants and the sequence comprises information without re-generating the FPGA code.

11. The method according to claim 1, further comprising simulating the circuit by the simulator and the hardware accelerator using the amended logic, wherein the simulating comprises sending input signals from the simulator to the hardware accelerator and sending output signals from the hardware accelerator to the simulator.

12. The method according to claim 1, comprising storing at least a portion of the sequence information in a memory module of the hardware accelerator, the memory module is coupled to the FPGA.

13. The method according to claim 1, wherein the FPGA code comprises multiple FPGA code segments and the method comprises programming multiple FPGAs of the hardware accelerator by the multiple FPGA code segments.

14. The method according to claim 1, wherein the hardware accelerator comprises multiple boards.

15. A computer program product that comprises a non-transitory computer readable medium that stores instructions for:
receiving a model of a circuit that comprises logic that is designed to receive at least one out of sequence information and constants from at least one input module of the circuit;
updating the model of the circuit or generating a new model of the circuit, the model comprises an interface and an initialization module, wherein the initialization module is arranged to provide, to a hardware accelerator and during an initialization of a simulation of the circuit, at least one out of constants and the sequence information; wherein the interface is arranged to interface between a simulator that simulates the at least one input module and a hardware accelerator that comprises a Field Programmable Gate Array (FPGA); and
generating FPGA code of an amended logic that comprises the logic and a programmable module; wherein the programmable module is arranged to receive, during the initialization of the simulation, at least one out of the constants and the sequence information, and to provide during the simulation and to the logic, at least one out of (a) the constants, and (b) at least one sequence represented by the sequence information.

16. The computer program product according to claim 15, wherein the sequence information is the sequence and wherein the programmable module is a buffer arranged to store the sequence and to output the sequence during the simulation.

17. The computer program product according to claim 15, wherein the sequence information comprises parameters that represent the sequence and wherein the programmable module comprises a pattern generator that is arranged to output the sequence based on the parameters.

18. The computer program product according to claim 15, wherein the sequence information represents a cyclic sequence and wherein the programmable module is arranged to output the sequence in a cyclic manner during the simulation.

19. The computer program product according to claim 15, wherein the non-transitory computer readable medium stores instructions for updating the model of the circuit to comprise the initialization module, wherein the initialization module is arranged to provide, to the hardware accelerator, the sequence information during an initialization of a simulation iteration of the circuit.

20. The computer program product according to claim 15, wherein the sequence information represents a sequence that has a first portion and a second portion wherein the second portion comprises multiple repetitions of a same value.

21. The computer program product according to claim 15, wherein the non-transitory computer readable medium stores instructions for updating the model of the circuit to comprise the initialization module, wherein the initialization module is arranged to provide, to the hardware accelerator, the constants during an initialization of a simulation iteration of the circuit.

22. The computer program product according to claim 15, wherein the non-transitory computer readable medium stores instructions for:
updating the model of the circuit to comprise the interface and the initialization module, wherein the initialization module is arranged to provide, to a hardware accelerator and during an initialization of a simulation of the circuit, constants; and
generating the FPGA code of the amended logic that comprises the logic and a programmable module; wherein the programmable module is arranged to receive, during the initialization of the simulation, the constants, and to provide during the simulation and to the logic, the constants.

23. The computer program product according to claim 15, wherein the non-transitory computer readable medium stores instructions for:
updating the model of the circuit to comprise the interface and the initialization module, wherein the initialization module is arranged to provide, to a hardware accelerator and during an initialization of a simulation of the circuit, sequence information; and
generating the FPGA code of the amended logic that comprises the logic and a programmable module; wherein the programmable module is arranged to receive, during the initialization of the simulation, the sequence information, and to provide during the simulation and to the logic, the sequence.

24. The computer program product according to claim 15, wherein the non-transitory computer readable medium stores instructions for changing of value of either one of the constants and the sequence comprises information without re-generating the FPGA code.

25. The computer program product according to claim 15, wherein the non-transitory computer readable medium stores instructions for simulating the circuit by the simulator and the hardware accelerator using the amended logic, wherein the simulating comprises sending input signals from the simulator to the hardware accelerator and sending output signals from the hardware accelerator to the simulator.

26. The computer program product according to claim 15, wherein the non-transitory computer readable medium stores instructions for storing at least a portion of the sequence information in a memory module of the hardware accelerator, the memory module is coupled to the FPGA.

27. The computer program product according to claim 15, wherein the FPGA code comprises multiple FPGA code segments and the wherein the non-transitory computer readable medium stores instructions for programming multiple FPGAs of the hardware accelerator by the multiple FPGA code segments.

28. The computer program product according to claim 15, wherein the hardware accelerator comprises multiple boards.

29. A system comprising a simulator, a code generator and a hardware accelerator;
wherein the simulator is arranged to generate inputs to input modules and to receive outputs from output modules;
wherein the hardware accelerator comprises a Field Programmable Gate Array (FPGA); and
wherein the code generator is arranged to:
receive a model of a circuit that comprises logic that is designed to receive at least one out of sequence information and constants from the input modules;
update the model of the circuit or generate a new model of the circuit, the model comprises an interface and an initialization module, wherein the initialization module is arranged to provide, to a hardware accelerator and during an initialization of a simulation of the circuit, at least one out of constants and the sequence information; wherein the interface is arranged to interface between a simulator that simulates the at least one input module and a hardware accelerator that comprises a Field Programmable Gate Array (FPGA); and
generate FPGA code of an amended logic that comprises the logic and a programmable module; wherein the programmable module is arranged to receive, during the initialization of the simulation, at least one out of the constants and the sequence information, and to provide during the simulation and to the logic, at least one out of (a) the constants, and (b) at least one sequence represented by the sequence information;
wherein the interface is arranged to interface between the simulator and the hardware accelerator that comprises a Field Programmable Gate Array (FPGA).

30. The system according to claim 29 wherein the code generator is arranged to generate FPGA code of an amended logic that comprises the logic and a programmable module; wherein the programmable module is arranged to receive, during the initialization of the simulation, at least one out of the constants and the sequence information, and to provide during the simulation and to the logic, at least one out of the constants and a sequence represented by the sequence information.

31. The system according to claim 29 wherein the simulator and the hardware accelerator are arranged to exchange signals during a simulation of the circuit.
